(19) United States
(12) Patent Application Publication
(10) Pub. No.: US 2005/0283764 A1
(43) Pub. Date: Dec. 22, 2005

(54) Method and apparatus for validating a voice application

(76) Inventor: Leo Chiu, Daly City, CA (US)

Correspondence Address: CENTRAL COAST PATENT AGENCY, PO BOX 187, AROMAS, CA, 95004, US

(21) Appl. No.: 10/887,448

(22) Filed: Jul. 7, 2004

Related U.S. Application Data
(63) Continuation-in-part of application No. 10/835,444, filed on Apr. 28, 2004.
(60) Provisional application No. 60/574,041, filed on May 24, 2004.

(51) Int. Cl. G06F 9/44

(52) U.S. Cl. 717/125; 717/124

(57) ABSTRACT

A software interface for validating components and resources used in one or more network-based voice applications has a portion for excepting s user input to select component or resource types to validate; a portion for compiling any errors or conflicts found relating to the component and resource types selected; and a portion for displaying a list of any errors or conflicts found. In a preferred embodiment the interface returns any errors found in a navigable list that is linked to another interface enabling navigation to and editing of individual errors or conflicts found.

### CROSS-REFERENCE TO RELATED DOCUMENTS

The present invention claims priority to provisional patent application Ser. No. 60/574,041 filed on May 24, 2004 The present invention is also continuation in part to a U.S. patent application Ser. No. 10/835,444 entitled “System for Managing Voice Files of a Voice Prompt Server”, filed on Apr. 28, 2004 disclosure of which is included herein.

### FIELD OF THE INVENTION

The present invention is in the area of voice application software systems and pertains particularly to methods and software for validating voice applications for accuracy and function before deployment for service to a voice application system.

### BACKGROUND OF THE INVENTION

A speech application is one of the most challenging applications to develop, deploy and maintain in a communications environment. Expertise required for developing and deploying a viable VXML application, for example, includes expertise in computer telephony integration (CTI) hardware and software or a data network telephony (DNT) equivalent, voice recognition software, text-to-speech software, and speech application logic.

With the relatively recent advent of voice extensive markup language (VXML) the expertise require to develop a speech solution has been reduced somewhat. VXML is a language that enables a software developer to focus on the application logic of the voice application without being required to configuring underlying telephony components. Typically, the developed voice application is run on a VXML interpreter that resides on and executes on the associated telephony system to deliver the solution.

Voice prompting systems in use to day range from a simple interactive voice response system for telephony to the more state-of-art VXML application system known to the inventors. Anywhere a customer telephony interface may be employed; there may also be a voice interaction system in place to interact with callers in real time. Data network telephony (DNT) equivalents of voice delivery system also exist like VoIP portals and the like.

Often in both VXML compliant and non-VXML systems, such as computer telephony integrated (CTI) IVRs, voice messaging services and the like, voice prompts are sometimes prerecorded in a studio setting for a number of differing business scenarios and uploaded to the enterprise system server architecture for access and deployment during actual interaction with clients. Pre-recording voice prompts instead of dynamically creating them through software and voice synthesis methods is many times performed when better sound quality, different languages, different voice types, or a combination of the above are desired for the presentation logic of a particular system.

In very large enterprise architectures there may be many thousands of prerecorded voice prompts stored for use by a given voice application. Some of these may not be stored in a same centralized location. One with general knowledge of voice file management will attest that managing such a large volume of voice prompts can be very complicated. For example, in prior-art systems management of voice prompts includes recording the prompts, managing identification of those prompts and manually referencing the required prompts in the application code used in developing the application logic for deployment of those prompts to a client interfacing system. There is much room for error in code referencing and actual development, recording, and sorting batches of voice files can be error prone and time consuming as well.

The inventor is aware, at the time of this writing, of a software interface for managing audio resources used in one or more voice applications. This interface is described with reference to Ser. No. 10/835,444 listed as a cross-reference in this specification. The software interface includes a first portion thereof for mapping the audio resources from storage to use-case positions in the one or more voice applications, a portion thereof for accessing the audio resources according to the mapping information and for performing modifications there of, a portion thereof for creating new audio resources; and a portion thereof for replication of modifications across distributed facilities. In a preferred application a developer can modify or replace existing audio resources and replicate links to the application code of the applications that use them.

It is important that all voice applications relying on audio resources and other components like data adaptors, enterprise rules, and links, such as universal resource locators to external on-line audio resources, be properly tested and validated before being deployed to a customer interface. A voice application may involve many variables and orders of execution. A voice application processor, also known to the inventors as a dialog controller, executes and manages state of a voice application in service. All of the parameters, such as queue order for dialogs and dialog sequences; pointers to the appropriate data adaptors for on-line or externally-stored audio data or text data (TTS); must be verifiable and should be known to be reliable in terms of performance for the application to be deployed and for the application to load and play successfully at the location of the customer interface.

Such testing in current art comprises much manual selecting of components and validation of attributes. In many cases, an error or more than one error exists in a voice application but the author is not informed of the exact nature of the error or where the error has occurred with respect to internal or distributed components responsible for the application's success. For example, if an application utilizes one or more external audio or text resources that are mapped to a certain location in a host machine or repository, it is possible that the mapping information may be changed for one or more of those resources causing a voice application to crash or hang because it could not access one or more variables.

One other drawback for a voice application that references external resources is that a single resource may be referenced many times in the application code. Therefore, it is important that if a resource link is down or has been changed, or a resource has been moved since the last deployment of the application, the correct information be quickly updated to all of the application code fields that reference the information. In prior-art manual testing sequences it is extremely easy to leave a correction out of one or more of the application code fields, especially if there are many to contend with.

Therefore, what is needed in the art is a validation method and system that can be used to quickly validate a voice application before initial deployment and, preferably, periodically before subsequent deployments, to insure that the application will work successfully in service every time that it is deployed.

### SUMMARY OF THE INVENTION

A software interface for validating components and resources used in one or more network-based voice applications is provided. The interface includes a portion for excepting user input to select component or resource types to validate; a portion for compiling any errors or conflicts found relating to the component and resource types selected; and a portion for displaying a list of any errors or conflicts found.

In one embodiment, the software interface of claim is accessible from a node connected to a network local to the voice application components and resources. In another embodiment, the software interface is accessible from a node connected to a network remote from the voice application components and resources.

In a preferred embodiment, the list of errors is displayed in a form that is network-navigable. In this embodiment the software interface is integrated with an interface enabling edits and modifications.

Components and resources that may be validated include one or more of but are not limited to voice application variables, dialogs, dialog prompts, data adapters, scripts, external data sources, internal data sources, rules, universally recognized words, communication protocols, and thesaurus lists. Validation includes one or more of validating identification of; presence of; correct application code reference to; correct internal mapping to; and correct external mapping to components and resources of type selected.

In one embodiment, the access point for operating the interface is a node on a local area network. In another embodiment, the access point for operating the interface is a node on a wide area network.

In one embodiment, the portions for compiling and for presenting found errors or conflicts operate transparently to the operator and cause transparent navigation to each found error using the interface for editing.

In one embodiment, an error found may constitute an incorrect resource location or mapping from a dialog processor to a mapped resource or component. In one aspect of this embodiment, the incorrect location or mapping is one of a universal resource indicator or a universal resource locator. In a preferred embodiment, validation of rules includes validation of rule expressions.

According to another aspect of the present invention, a method for identifying and presenting one or more errors or conflicts related to components and resources used in one or more voice applications is provided. The method includes steps of (a) selecting, in an interactive interface, the component and resource types of the application or applications to be considered for error identification; (b) initiating a process for scanning the components and resources to identify and log any errors or conflicts found; (c) scanning the identified component and resource parameters and detecting any errors or conflicts related thereto; (d) compiling an error list of those one or more errors or conflicts logged; and (e) displaying the list of errors and conflicts found or a certain element or elements of the list to an operator either in an edit-enabling interface or in an interface of a navigable form.

In one aspect, in step (a) the interface includes a portion for accepting user input to select component or resource types to validate; a portion for compiling any errors or conflicts found relating to the component and resource types selected; and a portion for displaying a list of any errors or conflicts found.

In a preferred aspect, in step (a), the components and resources include one or more of but are not limited to voice application variables, dialogs, dialog prompts, data adapters, scripts, external data sources, internal data sources, rules, universally recognized words, communication protocols, and thesaurus lists.

In one aspect, in step (a), the interface is accessible to a node connected to a network local to the voice application components and resources. In another aspect in step (a), the interface is accessible to a node connected to a network remote from the voice application components and resources. In a preferred aspect, in step (a), the interface is integrated with an interface enabling edits and modifications. In one aspect in step (b), the process is initiated through the same interface of step (a).

In one aspect, steps (c) and (d) are automated and transparent to the user. In a preferred aspect in step (c), parameters include one or more of but are not limited to parameters about voice application variables, dialogs, dialog prompts, data adapters, scripts, external data sources, internal data sources, rules, universally recognized words, communication protocols, and thesaurus lists.

In one aspect, in step (c), errors or conflicts relate to attempted validation of one or more of parameters related to identification of components or resources; presence of components or resources; correct application code reference to components or resources; correct internal mapping of components or resources; and correct external mapping of components or resources.

In one aspect, in step (e), the list is presented to the edit-enabling interface as each error location is navigated to one error at a time, the navigation action transparent to the user. In another aspect, in step (e), the list is presented to the navigable interface wherein the user may physically select an item from the list causing invocation of the edit-enabling interface and navigation to the error location for editing from within the interface.

### BRIEF DESCRIPTION OF THE DRAWING FIGURES

FIG. 1 is a logical overview of a voice interaction server and voice prompt data store according to prior-art.

FIG. 2 is a block diagram illustrating voice prompt development and linking to a voice prompt application according to prior art.

FIG. 3 is a block diagram illustrating a voice prompt development and management system according to an embodiment of the present invention.

FIG. 4 illustrates an interactive screen for a voice application resource management application according to an embodiment of the present invention.

FIG. 5 illustrates an interactive screen having audio resource details and dependencies according to an embodiment of the present invention.

FIG. 6 illustrates an interactive screen for an audio resource manager illustrating further details and options for editing and management according to an embodiment of the present invention.

FIG. 7 is a process flow diagram illustrating steps for editing or replacing an existing audio resource and replicating the resource to distributed storage facilities.

FIG. 8A is a screen shot of a pop-up validator window for initiating validation of a voice application according to an embodiment of the present invention.

FIG. 8B is a screen shot 806 of a pop-up validation result window for listing found errors according to an embodiment of the present invention.

FIG. 9 is a screen shot 900 of a pop-up validation result window for listing found errors according to another embodiment of the present invention.

FIG. 10 is a screen shot 1000 of an edit-capable interface for editing or fixing error states found during validation according to an embodiment of the present invention.

FIG. 11 is a process flow diagram illustrating steps for identifying and compiling a list of voice application errors according to an embodiment of the present invention.

### DESCRIPTION OF THE PREFERRED EMBODIMENTS

The inventor provides a system for managing voice prompts in a voice application system. Detail about methods, apparatus and the system as a whole are described in enabling detail below.

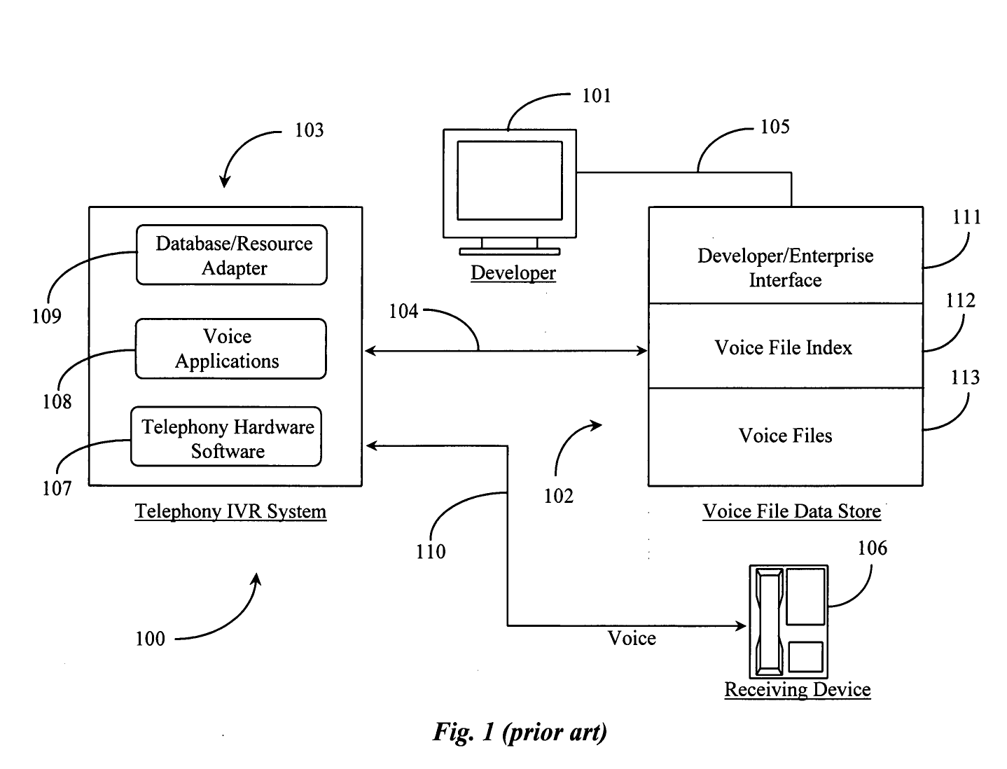

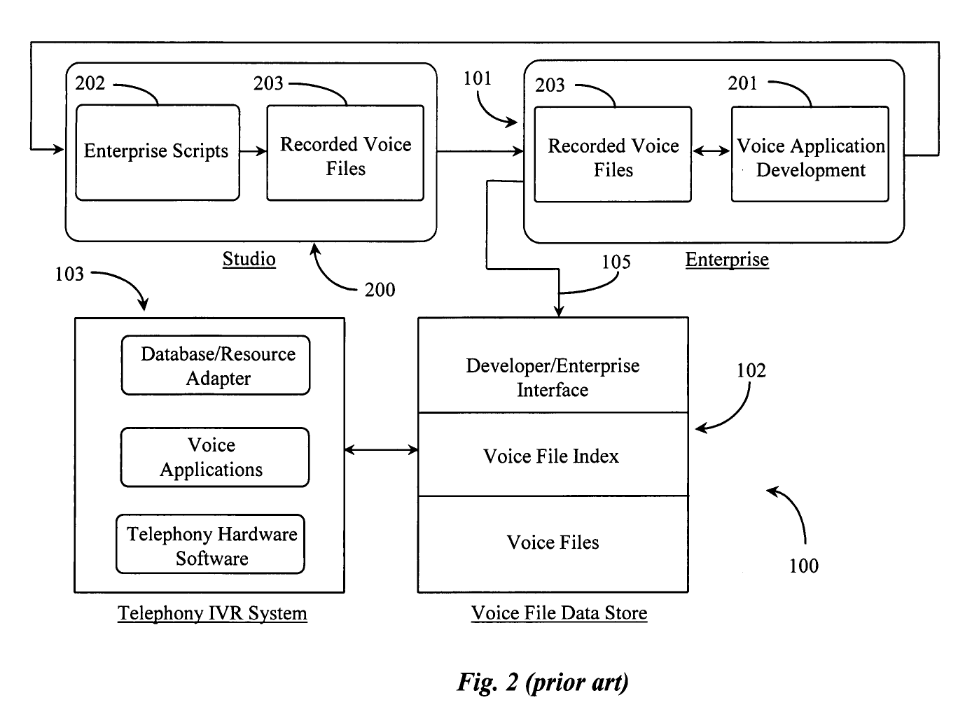

FIG. 1 is a logical overview of a voice interaction server and voice prompt data store according to prior art. FIG. 2 is a block diagram illustrating voice prompt development and linking to a voice prompt application according to prior art. A voice application system 100 includes a developer 101, a voice file storage medium 102, a voice portal (telephony, IVR) 103, and one of possibly hundreds or thousands of receiving devices 106.

Device 106 may be a LAN-line telephone, a cellular wireless, or any other communication device that supports voice and text communication over a network. In this example, device 106 is a plane old telephone service (POTS) telephone.

Device 106 has access through a typical telephone service network, represented herein by a voice link 110, to a voice system 103, which in this example is a standard telephony IVR system. IVR system 103 is the customer access point for callers (device 106) to any enterprise hosting or leasing the system.

IVR 103 has a database/resource adapter 109 for enabling access to off- system data. IVR also has voice applications 108 accessible therein and adapted to provide customer interaction and call flow management. Applications 108 include the capabilities of prompting a customer, taking input from a customer and playing prompts back to the customer depending on the input received.

Telephony hardware and software 107 includes the hardware and software that may be necessary for customer connection and management of call control protocols. IVR 103 may be a telephony switch enhanced as a customer interface by applications 108. Voice prompts executed within system 103 may include only prerecorded prompts. A DNT equivalent may use both prerecorded prompts and XML-based scripts that are interpreted by a text-to-speech engine and played using a sampled voice.

IVR system 103 has access to a voice file data store 102 via a data link 104, which may be a high-speed fiber optics link or another suitable data carrier many of which are known and available. Data store 102 is adapted to contain prerecorded voice files, sometimes referred to as prompts. Prompts are maintained, in this example, in a section 113 of data store 102 adapted for the purpose of storing them. A voice file index 112 is illustrated and provides a means for searching store section 113 to access files for transmission over link 104 to IVR system 103 to be played by one of applications 108 during interaction with a client.

In this case IVR system 102 is a distributed system such as to a telephony switch location in a public switched telephone network (PSTN) and therefore is not equipped to store many voice files, which take up considerable storage space if they are high quality recordings.

Data store 111 has a developer/enterprise interface 111 for enabling developers such as developer 101 access for revising existing voice files and storing new and deleting old voice files from the data store. Developer 101 may create voice applications and link stored voice files to the application code for each voice application created and deployed. Typically, the voice files themselves are created in a separate studio from script provided by the developer.

As was described with reference to the background section, for a large enterprise there may be many thousands of individual voice prompts, many of which are linked together in segmented prompts or prompts that are played in a voice application wherein the prompts contain more than one separate voice file. Manually linking the original files to the application code when creating the application provides enormous room for human error. Although the applications are typically tested before deployment, errors may still get through causing monetary loss at the point of customer interface.

Another point of human management is between the studio and the developer. The studio has to manage the files and present them to the developer in a fashion that the developer can manipulate in an organized fashion. As the number of individual prerecorded files increases, so does the complexity of managing those prerecorded files.

Referring now to FIG. 2, developer 101 engages in voice application development activity 201. Typically voice files are recorded from script. Therefore, for a particular application developer 101 creates enterprise scripts 202 and sends them out to a studio (200) to be recorded. An operator within studio 200 receives scripts 202 and creates recorded voice files 203. Typically, the files are single segments, some of which may be strategically linked together in a voice application to play as a single voice prompt to a client as part of a dialog executed from the point of IVR 103, for example.

The enterprise must insure that voice files 203 are all current and correct and that the parent application has all of the appropriate linking in the appropriate junctions so that the files may be called up correctly during execution. Developer 101 uploads files 203 when complete to data store 102 and the related application may also be uploaded to data store 102. When a specific application needs to be run at a customer interface, it may be distributed without the voice files to the point of interface, in this case IVR 103. There may be many separate applications or sub-dialogs that use the same individual voice files. Often there will be many instances of the same voice file stored in data store 102 but linked to separate applications that use the same prompt in some sequence.

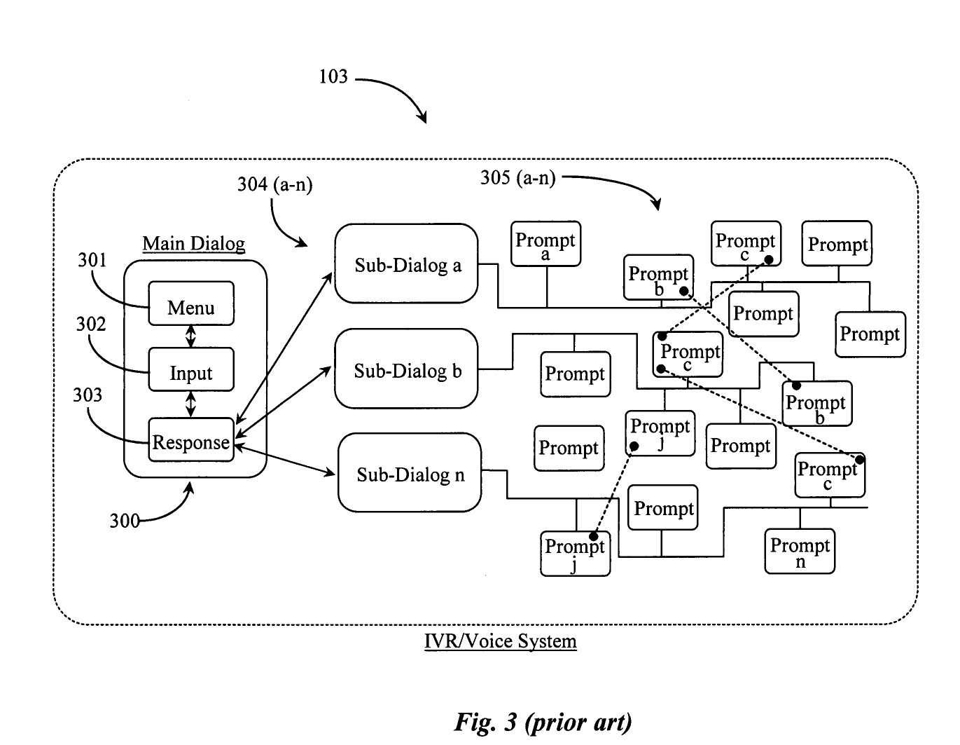

FIG. 3 is an expanded view of IVR 103 of FIG. 2 illustrating a main dialog and sub-dialogs of a voice application according to prior art. In many systems, a main dialog 300 includes a static interactive menu 301 that is executed as part of the application logic for every client that calls in. During playing of menu 300, a client may provide input 302, typically in the form of voice for systems equipped with voice recognition technology. A system response 303 is played according to input 302.

System response 303 may include as options, sub-dialogs 304(a-n). Sub-dialogs 304(a-n) may link any number of prompts, or voice files 305(a-n) illustrated logically herein for each illustrated sub-dialog. In this case prompt 305b is used in sub-dialog 304a and in sub-dialog 304b. Prompt 305c is used in all three sub-dialogs illustrated. Prompt 305a is used in sub-dialog 304b and in sub-dialog 304b. Prompts are created at the time of application creation and deployment. Therefore prompts 305b, c, and j are stored in separate versions and locations for each voice application.

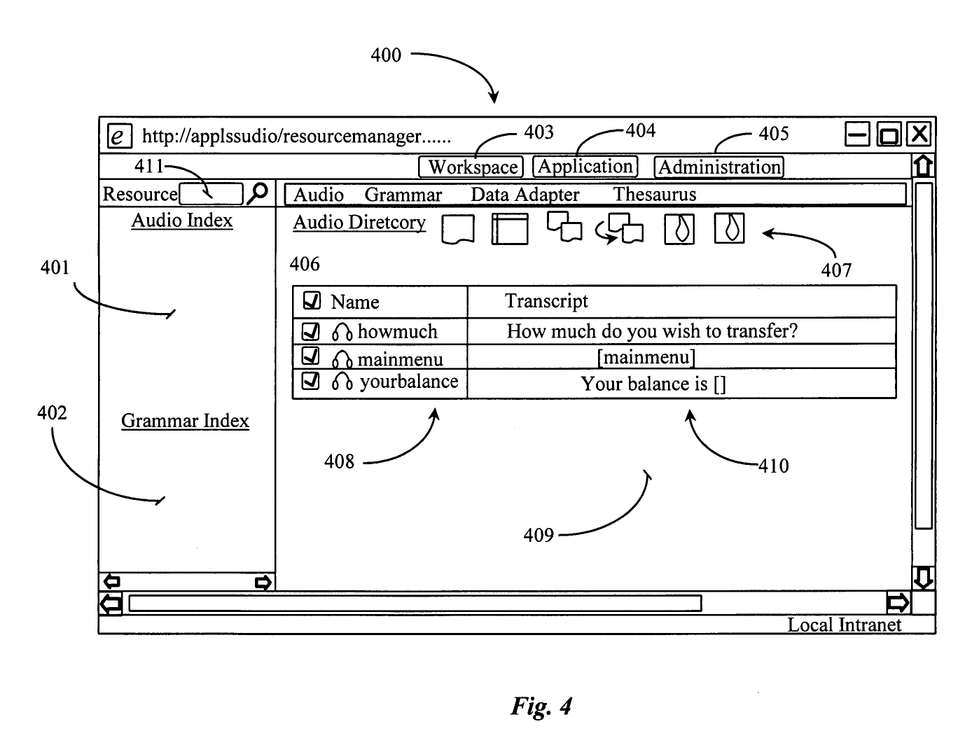

FIG. 4 illustrates an interactive screen 400 for a voice application resource management application according to an embodiment of the present invention. Screen 400 is a GUI portion of a software application that enables a developer to create and manage resources used in voice applications. Resources include both audio resources and application scripts that may be voice synthesized. For the purpose of this example, the inventor focuses on management of audio resources, which in this case, include voice file or prompt management in the context of one or more voice file applications.

Screen 400 takes the form of a Web browser type interface and can be used to access remote resources over a local area network (LAN), wide area network (WAN), or a metropolitan area network (MAN). In this example, a developer operating through screen 400 is accessing a local Intranet.

Screen 400 has a toolbar link 403 that is labeled workspace. Link 403 is adapted to open, upon invocation, a second window or changes the primary window to provide an area for working and audio management and creation tools for creating and working with audio files and transcripts or scripts.

Screen 400 has a toolbar link 404 that is labeled application. Link 404 is adapted to open, upon invocation, a second window or changes the primary window to provide an area for displaying and working with voice application code and provides audio resource linking capability. Screen 400 also has a toolbar link for enabling an administration view of all activity.

Screen 400 has additional toolbar links 406 adapted for navigating to different windows generally defined by label. Reading from left to right in toolbar options 406, there is Audio, Grammar, Data Adapter, and Thesaurus. The option Audio enables a user to view all audio-related resources. The option Grammar enables a user to view all grammar-related resources. The option Data Adapter enables a user to view all of the available adapters used with data sources, including adapters that might exist between disparate data formats. The option Thesaurus is self-descriptive.

In this example, a developer has accessed the audio resource view, which provides in window 409 an interactive data list 411 of existing audio resources currently available in the system. List 411 is divided into two columns a column 408 labeled “name” and a column 410 labeled “transcript”. In this example there are three illustrated audio prompts reading from top to bottom from list 411 column 408 they are “howmuch”, “mainmenu”, and “yourbalance”. An audio speaker icon next to each list item indicates the item is an audio resource and enable a developer to. Each audio resource is associated with the appropriate transcript of the resource as illustrated in column 410. Reading from top to bottom in column 410 for the audio resource “howmuch” the transcript is “How much do you wish to transfer?” For “mainmenu”, the transcript is longer, therefore it in not reproduced in the illustration but may be assumed to be provided in full text. A scroll function may be provided to scroll a long transcript associated with an audio resource. For the audio resource “yourbalance”, the transcript is “Your balance is [ ]. The brackets enclose a variable used in a voice system prompt response to a client input interpreted by the system.

In one embodiment there may be additional options for viewing list 411, for example, separate views of directory 411 may be provided in different languages. In one embodiment, separate views of directory 411 may be provided for the same resources recorded using different voice talents. In the case of voice files that are contextually the same, but are recorded using different voice talents and or languages, those files may be stored together and versioned according to language and talent.

Window 409 can be scrollable to reach any audio resources not viewable in the immediate screen area. Likewise, in some embodiments a left-side navigation window may be provided that contains both audio resource and grammar resource indexes 401 and 402 respectively to enable quick navigation through the lists. A resource search function 411 is also provided in this example to enable keyword searching of audio and grammar resources.

Screen 400 has operational connectivity to a data store or stores used to where house the audio and grammar resources and, in some cases, the complete voice applications. Management actions initiated through the interface are applied automatically to the resources and voice applications.

A set of icons 407 defines additional interactive options for initiating immediate actions or views. For example, accounting from left to right a first icon enables creation of a new audio resource from a written script. Invocation of this icon brings up audio recording and editing tools that can be used to create new audio voice files and that can be used to edit or version existing audio voice files. A second icon is a recycle bin for deleting audio resources. A third icon in grouping 407 enables an audio resource to be copied. A fourth icon in grouping 407 enables a developer to view a dependency tree illustrating if where and when the audio file is used in one or more voice dialogs. The remaining two icons are upload and download S icons enabling the movement of audio resources from local to remote and from remote to local storage devices.

In one embodiment of the present invention, the functions of creating voice files and linking them to voice applications can be coordinated through interface 400 by enabling an author of voice files password protected local or remote access for downloading enterprise scripts and for uploading new voice files to the enterprise voice file database. By marking audio resources in list 410 and invoking the icon 407 adapted to view audio resource dependencies, an operator calls up a next screen illustrating more detail about the resources and further options for editing and management as will be described below.

Screen 400, in this example, has and audio index display area 401 and a grammar display index area 402 strategically located in a left scrollable sub-window of screen 400. As detailed information is viewed for a resource in window 409, the same resource may be highlighted in the associated index 401 or 402 depending on the type of resource listed.

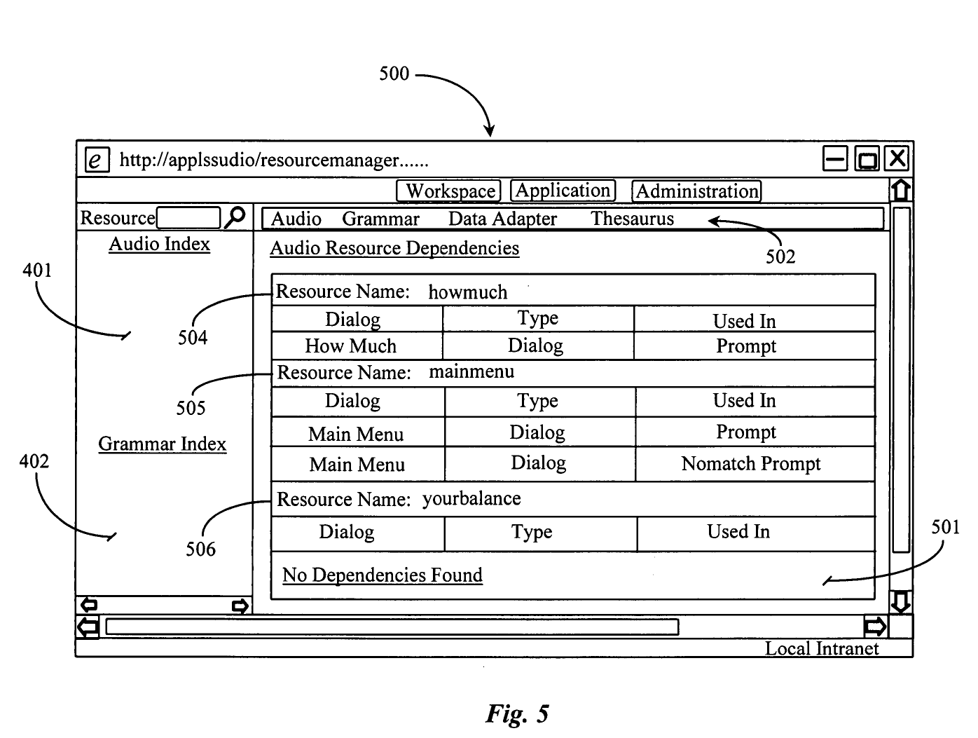

FIG. 5 is illustrates an interactive screen 500 showing audio resource details and dependencies according to an embodiment of the present invention. Screen 500 has a scrollable main window 501 that is adapted to display further details about audio resources previously selected for view. Previous options 406 remain displayed in screen 500. In this example each resource selected in screen 400 is displayed in list form In this view audio resource 504 has a resource name “howmuch”. The resource 504 is categorized according to Dialog, Dialog type, and where the resource is used in existing voice applications. In the case of resource 504, the dialog reference is “How Much”, the resource type is a dialog, and the resource is used in a specified dialog prompt. Only one dependency is listed for audio resource 504, however all dependencies (if more than one) will be listed.

Resource 505, “mainmenu” has dependency to two main menus associated with dialogs. In the first listing the resource is used in a standard prompt used in the first listed dialog of the first listed main menu. In the second row it is illustrated that the same audio resource also is used in a nomatch prompt used in a specified dialog associated with the second listed main menu. For the purpose of this specification a nomatch prompt is one where the system does not have to match any data provided in a response to the prompt. A noinput prompt is one where no input is solicited by the prompt. It is noted herein that for a general application prompt definitions may vary widely according to voice application protocols and constructs used. The dependencies listed for resource 505 may be associated with entirely different voice applications used by the same enterprise. They may also reflect dependency of the resource to two separate menus and dialogs of a same voice application.

No specific ID information is illustrated in this example, but may be assumed to be present. For example, there may be rows and columns added for displaying a URL or URI path to the instance of the resource identified. Project Name, Project ID, Project Date, Recording Status (new vs. recorded), Voice Talent, and Audio Format are just some of the detailed information that may be made available in window 501. There may be a row or column added for provision of a general description of the resource including size, file format type, general content, and so on.

Resource 506, “yourbalance” is listed with no dependencies found for the resource. This may be because it is a newly uploaded resource that has not yet been linked to voice application code. It may be that it is a discarded resource that is still physically maintained in a database for possible future use. The lack of information tells the operator that the resource is currently not being used anywhere in the system.

Screen 500, in this example, has audio index display area 401 and a grammar display index area 402 strategically located in a left scrollable sub-window of screen 500 as described with reference to screen 400 of FIG. 4 above. As detailed information is viewed for a resource in window 501, the same resource may be highlighted in the associated index 401 or 402 depending on the type of resource listed.

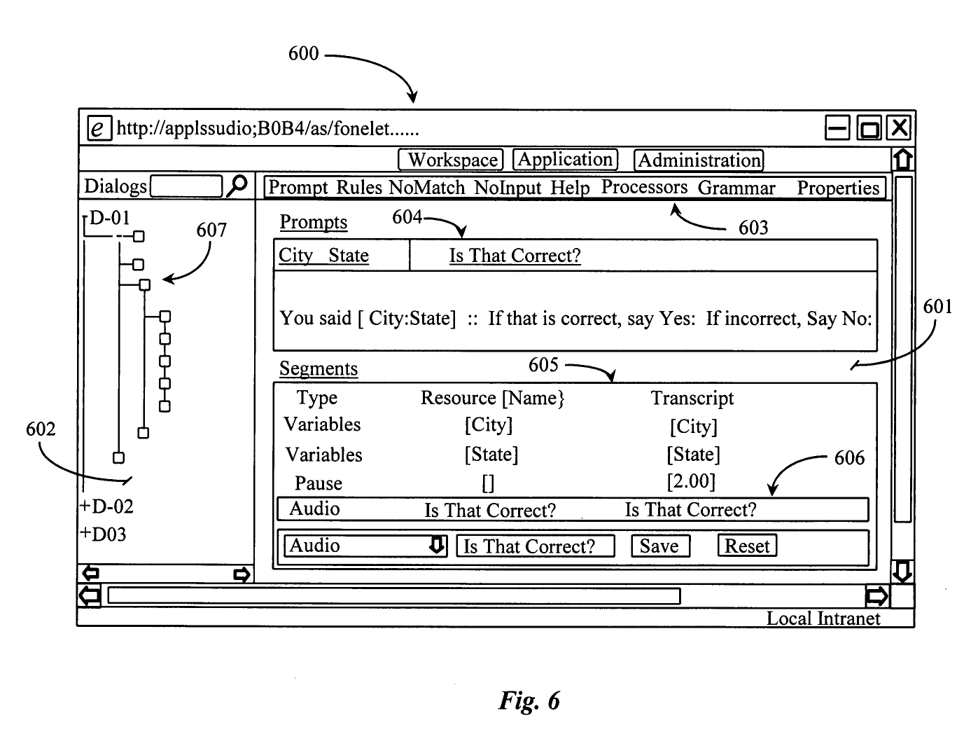

FIG. 6 illustrates an interactive screen 600 of an audio resource manager illustrating further details and options for editing and management according to an embodiment of the present invention. Screen 600 enables a developer to edit existing voice files and to create new voice files. A dialog tree window 602 is provided and is adapted to list all of the existing prompts and voice files linked to dialogs in voice applications. The information is, in a preferred embodiment, navigable using a convenient directory and file system format. Any voice prompt or audio resource displayed in the main window 601 is highlighted in the tree of window 602.

In one embodiment of the present invention from screen 500 described above, a developer can download a batch of audio resources (files) from a studio remotely, or from local storage and can link those into an existing dialog, or can create a new dialog using the new files. The process, in a preferred embodiment, leverages an existing database program such as MS Excel™ for versioning and keeping track of voice prompts dialogs, sub-dialogs, and other options executed during voice interaction.

In one embodiment of the present invention a developer can navigate using the mapping feature through all of the voice application dialogs referencing any selected voice files. In a variation of this embodiment the dialogs can be presented in descending or ascending orders according to some criteria specified like date, number of use positions, or some other hierarchical specification. In still another embodiment, a developer accessing an audio resource may also have access to any associated reference files like coaching notes, contextual notes, voice talent preferences, language preferences, and pronunciation nuances for different regions.

In a preferred embodiment, using the software of the present invention multiple links do not have to be created to replace an audio resource used in multiple dialog prompts of one or more voice applications. For example, after modifying a single voice file, one click may cause the link to the stored resource to be updated across all instances of the file in all existing applications. In another embodiment where multiple storage sites are used, replication may be ordered such that the modified file is automatically replicated to all of the appropriate storage sites for local access. In this case, the resource linking is updated to each voice application using the file according to the replication location for that application.

Screen 600 illustrates a prompt 604 being developed or modified. The prompt in this example is named “Is that correct?“and has variable input fields of City and State. The prompt 604 combines audio files to recite “You said [City: State]:: If that is correct, say Yes: If in correct, Say No: The prompt may be used in more than one dialog in more than one voice application. The prompt may incorporate more than one individual prerecorded voice file.

A window 605 contains segment information associated with the prompt “Is that correct?“such as the variable City and State and the optional transcripts (actual transcripts of voice files). New voice files and transcripts describing new cities and states may be added and automatically liked to all of the appropriate prompt segments used in all dialogs and applications.

Typically, audio voice files of a same content definition, but prerecorded in one or more different languages and/or voice talents will be stored as separate versions of the file. However, automated voice translation utilities can be used to translate an English voice file into a Spanish voice file, for example, on the fly as the file is being accessed and utilized in an application. Therefore, in a more advanced embodiment multiple physical prerecorded voice files do not have to be maintained.

Screen 600 has a set of options 603 for viewing creating or editing prompts, rules, nomatch prompts, and no-input prompts. Options for help, viewing processor details, help with grammar, and properties are also provided within option set 603. Workspace provides input screen or windows for adding new material and changes. The workspace windows can be in the form of an excel worksheet as previously described.

In one embodiment of the present invention linking voice files to prompts in application can be managed across multiple servers in a distributed network environment. Voice files, associated transcripts, prompt positions, dialog positions, and application associations are all automatically applied for the editor eliminating prior-art practice of re-linking the new resources in the application code. Other options not illustrated in this example may also be provided without departing from the spirit and scope of the present invention. For example, when a voice file used in several places has been modified, the editor may not want the exact version to be automatically placed in all use instances. In this case, the previous file is retained and the editor simply calls up a list of the use positions and selects only the positions that the new file applies to. The system then applies the new linking for only the selected prompts and dialogs. The old file retains the linking to the appropriate instances where no modification was required.

In another embodiment, voice file replication across distributed storage systems is automated for multiple distributed IVR systems or VXML portals. For example, if a developer makes changes to voice files in one storage facility and links those changes to all known instances of their use at other client access points, which may be widely distributed, then the distributed instances may automatically order replication of the appropriate audio resources from the first storage facility to all of the other required storage areas. Therefore, for voice applications that are maintained at local client-access facilities of a large enterprise that rely on local storage of prerecorded files can, after receiving notification of voice file linking to a new file or files can execute and order to retrieve those files from the original storage location and deposit them into their local stores for immediate access. The linking then is used as a road map to insure that all distributed sites using the same applications have access to all of the required files. In this embodiment audio resource editing can be performed at any network address wherein the changes can be automatically applied to all distributed facilities over a WAN.

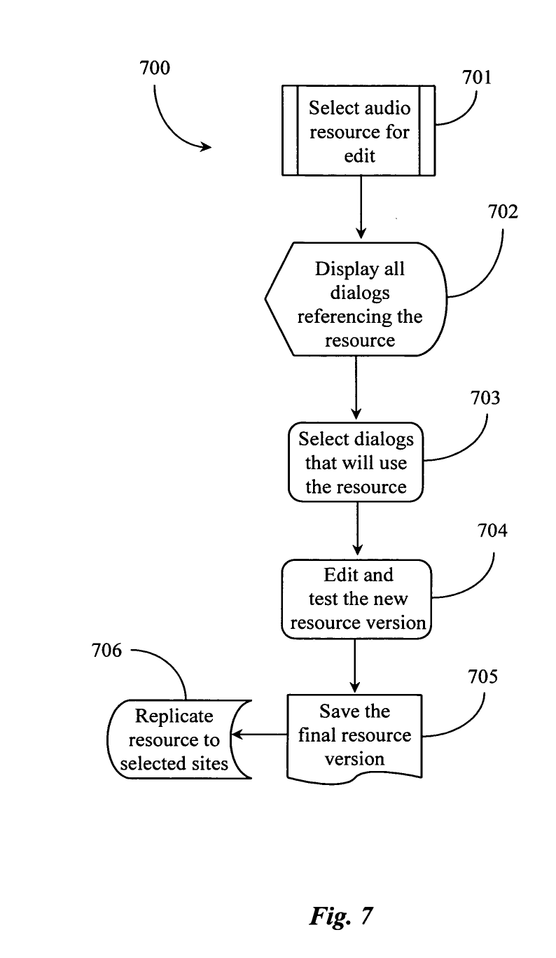

FIG. 7 is a process flow diagram 700 illustrating steps for editing or replacing an existing audio resource and replicating the resource to distributed storage facilities. At step 701, the developer selects an audio resource for edit or replacement. The selection can be based on a search action for a specific audio resource or from navigation through a voice application dialog menu tree.

At step 702 all dialogs that reference the selected audio resource are displayed. At step 703, the developer may select the dialogs that will use the edited or replacement resource by marking or highlighting those listed dialogs. In one embodiment all dialogs may be selected. The exact number of dialogs selected will depend on the enterprise purpose of the edit or replacement.

At step 704, the developer edits and tests the new resource, or creates an entirely new replacement resource. At step 705, the developer saves the final tested version of the resource. At step 706, the version saved is automatically replicated to the appropriate storage locations referenced by the dialogs selected in step 703. In this exemplary process, steps 702, and step 706 are automated results of the previous actions performed.

The methods and apparatus of the present invention can be applied on a local network using a central or distributed storage system as well as over a WAN using distributed or central storage. Management can be performed locally or remotely, such as by logging onto the Internet or an Intranet to access the software using password protection and/or other authentication procedures.

The methods and apparatus of the present invention greatly enhance and streamline voice application development and deployment and according to the embodiments described, can be applied over a variety of different network architectures including DNT and POTS implementations.

Voice Application Validation

According to one embodiment of the present invention, the inventor provides a method for validating a voice application for integrity and correctness before or after committing the application to service. The method and supporting apparatus will be described in enabling detail below.

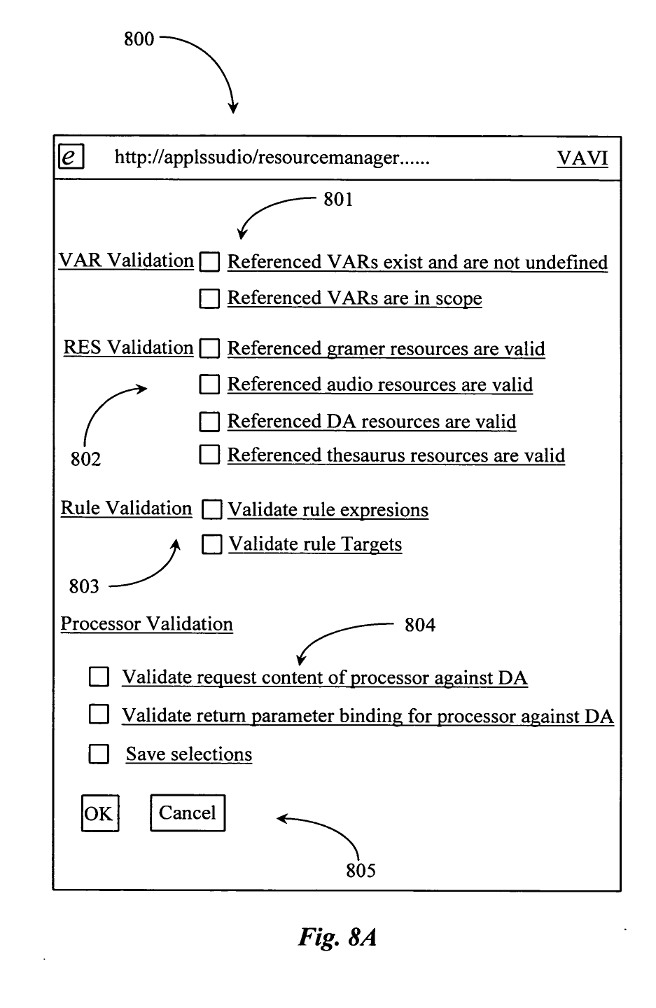

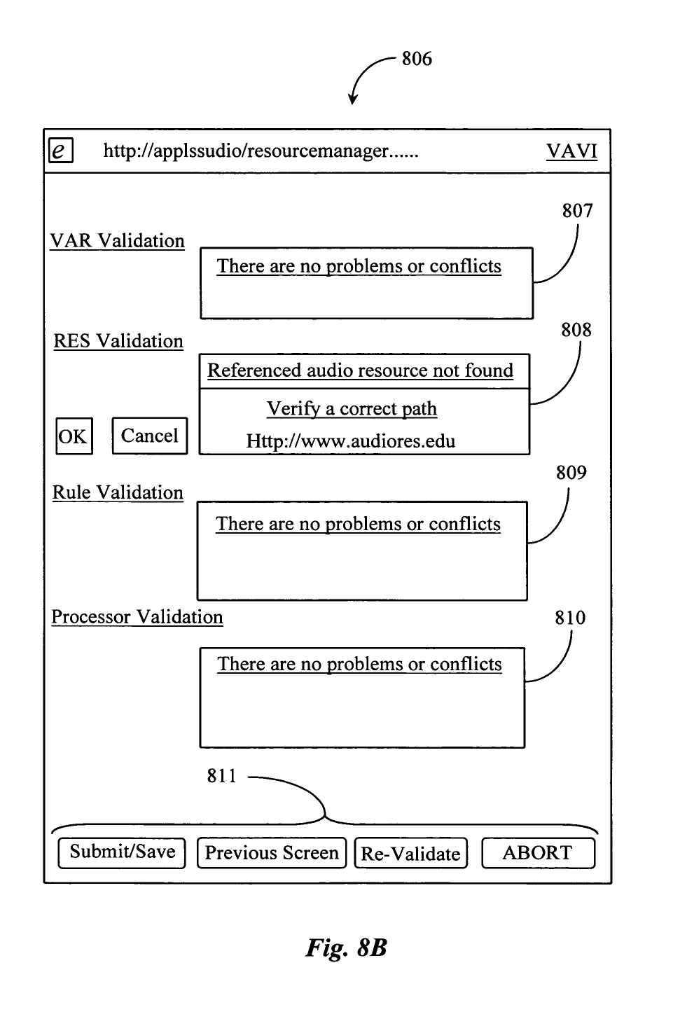

FIG. 8A represents an interactive screen 800 of a pop-up validator window for initiating validation of a voice application according to an embodiment of the present invention. Interactive screen 800 is, in a preferred embodiment, a pop-up screen and a functional, interactive window that may appear when a user operating the software described with reference to FIGS. 4-6 described above selects an option for testing an application after all of the resources have been mapped to the application code.

Screen 800 has a navigator bar bearing an HTTP address for providing access from a remote station over a data-packet network (DPN), and a resource name Validator Application Validation Interface (VAVI). Screen 800 has multiple validation options configured to various aspects of a voice application.

A validation option 801 is provided within screen 800 and is adapted to enable a user to validate that voice application variables (VARs) exist (have reference and correct mapping to the voice application code) and that such VARs are not undefined meaning that they are not null and holding no value. A variable (VAR) is one of a choice of prompts or files that may be played or not played according to client input as the client interacts with the application. Another VAR validation criteria enables a user to determine whether a referenced variable is in scope with the application context meaning that the variable can be successfully accessed and used according to the application criteria for incorporation of the variable.

Each sub-option for validating VARs has a check box associated for accepting a check mark inserted through input means such as by computer input methods. Checking both sub-options may create a full validation of all variables of the application. Not checking any boxes in option 801 will bypass validation for variables. Likewise, one of the boxes may be checked to validate according to the associated criteria.

Screen 800 has a validation option 802 for validating resources used by a voice application. For example, a first sub-option of option 802 enables a user to validate grammar resources (scripts for TTS) for content, mapping, and accessibility to the voice application code. A second sub-option in option 802 enables a user to validate audio resources or voice files that have mapping to and may be incorporated by the voice application. A next sub-option is provided in option 802 that enables a user to validate and data adaptors (DA) that may be used by the application when accessing grammar and audio resources. Such validation may determine the state, up or down, of a data adaptor, whether it is a correct data adaptor, and whether the mapping to a particular adaptor is correctly referenced in the application code. A last sub-option provided under option 802 enables a user to validate a thesaurus resource for mapping and for content with reference to the language and terminology intended and referenced in the voice application script and other audio or textual resources that may be variables.

A next validation option 803 enables a user to validate rule expressions created for voice application use and to validate that those rules contain or reference the correct target entities for the rule. For example, if a rule exists that determines which of two variables apply according to a particular dialog result, then the dialog for which the rues applies to and the exact position in the application flow should also be referenced as part of the target or rule target. There are varying rule types that may be included in rule validation without departing from the spirit and scope of the present invention.

A validation option 804 is provided within screen 800 and is adapted to enable a user to validate communication between a dialog controller or processor and the data adapter. For example, a fist sub-option is used to validate that request content from a dialog controller is correctly handled by the data adapter and a second sub-option is used to validate that the parameter returned through the data adapter are correct for the micro controller.

Similar to validation option 801, there are check boxes provided with each listed sub-option under validation options 802-804. In this way a user may select all boxes for a full validation run, or some sub-options for a customized validation run. In one embodiment of the present invention a user may schedule automated validation runs that may execute periodically or one time only at a date and time the user chooses.

FIG. 8B represents an interactive screen 806 as a pop-up validation result window for listing errors found during a validation run according to an embodiment of the present invention. Screen 806 may be provided in the same or in a similar physical display form as screen 800 described above. Screen 806 is adapted to return the results of a validation run initiated through interaction with screen 800 described above. As such, screen 806 similarly identifies a navigation address where the result screen may be repeatedly accessed after initial display, and the title of the application (VAVI). The screen address will be different from the initial interface (screen 800) reflecting further universal resource information (URI) such as . . . /validationresult/html for example.

In this example a result window 807 is provided within screen 806 and displays validation results found with respect to option 801 of FIG. 8A. In this case, there were no problems or conflicts detected. Therefore display 807 illustrates that all VAR parameters referenced in the application code are found and work correctly with the application.

With respect to resource (RES) validation, a result window 808 is provided that informs a user that a referenced audio resource is not found and suggests that the user verify a correct path to the resource. In this case, a user may type in the correct path and select an “ok” button to attempt to rectify the situation without navigating to the resource. In one embodiment, window 808 identifies exactly the name of the resource before asking for a correct path to the resource.

In still another embodiment, clicking on or anywhere within the window may launch an audio resource manager screen similar to screens 400, 500, or 600 described above. In this way a user may rectify the situation and run a re-validation attempt just for that sub-option criteria.

In one embodiment, the screen does not change in terms of physical layout and architecture from screen 800, only the screen contents m change where there is data that justifies a change. That is to say that if no problems are found at all in a given validation run, a short pop-up message may appear instead of screen 806.

A next result window 809 is provided within screen 806 and is adapted to display any results related to rule validation. In this case it is illustrated within window 809 that there are no problems or conflicts with any of the rules referenced in the application being tested. Rule validation verifies that target references subject to each rule are valid; essentially, the target is not a type [none]. It validates the order of queue IDs and whether they are valid in the rule expressions. Dialog IDs referenced in the rule expressions are also validated.

Rule validation enables a transition application or a next application ID to be validated for the voice application under consideration. Thesaurus IDs are validated for the voice application. Rule validation also validates all left-hand-side (LHS) expressions of any rule equality, for example if A=5 then the LHS expression is A. Finally, the rule validation process informs a user of the existence and location of any rules that have been nullified, disconnected or do not have target values.

Screen 806 has a validation result window 810 provided therein and adapted to inform a user of any processor problems or conflicts such as accessibility to any valid data adapters and configuration parameters between the processor and adapter(s). In example, the window displays that there are no problems or conflicts.

An option array 811 is provided within screen 806 and is adapted to enable user controls such as submit/save results, navigate to previous screen, revalidate using one or more options, and abort the process. In this example, screen 806 is a transition screen or sub-screen of the main interface, however, in one embodiment the application returns a screen that more resembles the main user interfaces of the resource creation and management application described wit respect to screens 400-600 described further above. Using the validation interface, a user may quickly validate and correct, if required, any portion of any voice application, initially before deployment and after creation and subsequently periodically during actual use of the application. The latter capacity is not specifically required in order to practice the present invention, however periodic validation sessions may help to ensure integrity in a fast-paced communication environment.

It will be apparent to one with skill in the art that the validator interface termed VAVI ca be provided and delivered to users in varying interactive form and capacity without departing from the spirit and scope of the present invention. For example, in one embodiment screens 800 and 806 are standalone Web forms that may be delivered to a requesting technician or administrator over a remote connection. In another embodiment screens 800 and 806 may be integrated parts of a larger resource management and voice application authoring software. An example of an integrated result-reporting interface is given below.

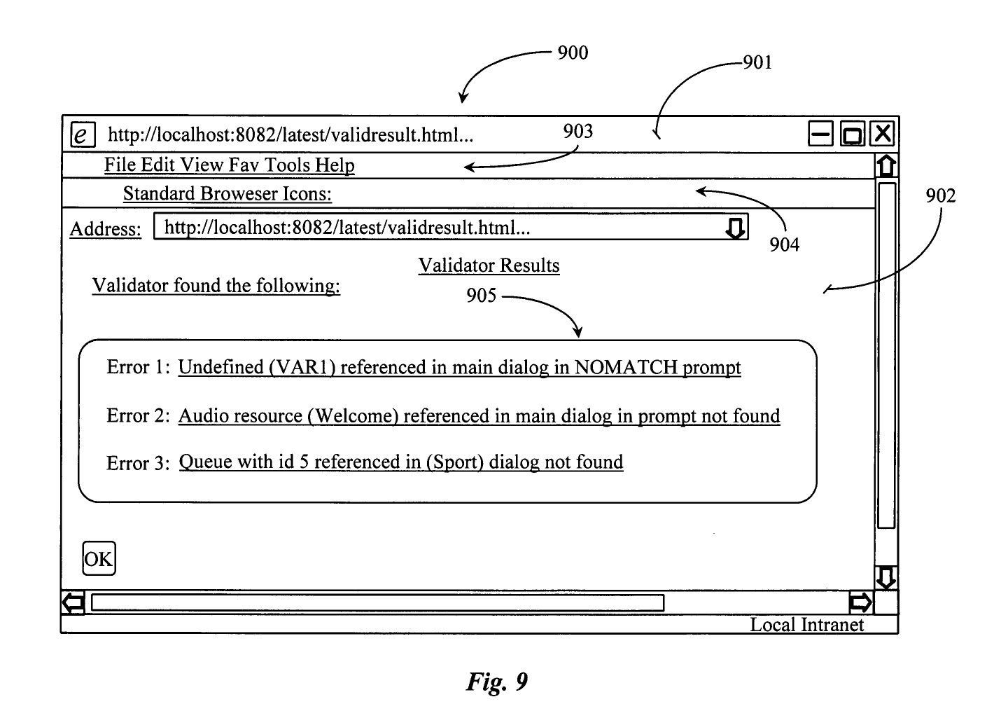

FIG. 9 represents an interactive screen 900 of a validation result window according to one embodiment of the present invention. Screen 900 assumes the form, in physical resemblance, of screens 400-600 described further above. Screen 900 in this embodiment provides an integrated page or interface window 902 that displays validation results 905 reported as a result of interaction with previously described screen 800 of FIG. 8A.

Screen 900 has an explorer bar 901 and a navigation address field similar to that of most browsing applications. Bar 901 displays the interface or screen location as is also displayed within the navigation window. Screen 900 has all of the standard file-option menus 903, and the standard browser icons 904.

In this embodiment, the validation results 905 only include errors, numbered errors 1, 2, and 3 in this example that were found in a validation run. Results 905 may be presented in a variety of acceptable orders such as chronological order as an error is discovered. Results 905 may, in one embodiment, be presented according to priority of the error, or perhaps, by category of error. There are many organizational possibilities.

Reading from top to bottom in results listing 905, error 1 reports that there was an undefined variable (VAR1) referenced in a main dialog of the voice application under consideration, the variable contained in a nomatch prompt. The error result lines 1, 2, and 3 are, in a preferred embodiment, navigationally linked to the actual component found to be in error wherein selection the error line causes display of the component location and edit capability thereof in a new window associated with a main voice application resource management interface containing the appropriate tools to correct the error.

Error line 2 informs the user that an audio resource (Welcome) referenced in the main dialog prompt of the voice application under validation was not found. In error line 3, the user is informed that queue id number 5 referenced in a sort dialog of the voice application under validation is not found. Below error window or list 905, there is an OK button. A user may activate this button to navigate one error at a time. As a user corrects an error satisfactorily, the next error in the list will be navigated to for user correction. Revalidation for each correction may, in one embodiment, be automatic and transparent to the user. Window 902 may be scrollable to enable a user to view a long list of errors before engaging in error correction.

Dialog Validation:

Although not specifically illustrated as a selectable validation option in FIG. 8A with reference to screen 800, the VAVI of the present invention may also enable dialog validation. For example, if no enumerable data adaptor or an nbest dialog option is assigned to a navigation dialog then the user may be informed of the error condition. For purposes of clarification, a navigation dialog is a dialog that references a list of items such as, for example, a number of accounts or a number of movie titles. To navigate a navigation dialog a caller would say commands like next, previous, skip or last in order to navigate the listed items.

An nbest dialog is a dynamic recognition dialog that may be presented to a caller as a navigation dialog or simply presented to a caller for validation from a speech engine as a result of some particular caller input where an (n) best number of matches associated with the caller input is returned. For example, if a caller says a particular word that is not exactly understood by the speech recognizer, an nbest dialog pre-set to return a number (n) of top candidates from a grammar pool, the candidates selected to most closely resemble what the engine heard from the caller under the conditions. If a grammar pool includes the words fire, fly, flower, five, high, and far, and the caller actually said fly, then the top candidates if the number is set to 3 might be fly, fire, and five. The caller might navigate the dialog as described above, or just validate the correct selection by repeating the word. In another embodiment, a pre-requisite dialog may be played prompting the caller by asking if the caller meant fly, fire, or five?

Dialog validation may be used to validate hotwords. A hotword is a globally recognized word in a voice application meaning that no matter where a caller is in a voice application tree, if he or she says a hotword that is included in a list of hotwords associated with the voice application, the application responds to the word according to voice application rules.

Validating hotwords means that the parameters lining the hotword list to the dialogs, thesaurus, etc. are correct including routing to actions, new dialogs, and so on that are invoked by the hotwords used in the voice application. For example, the validator makes sure that the dialog IDs are valid in application and in the hotword list. Likewise the thesaurus IDs re validated to the application and to the hotword list. Additionally, the validator verifies the existence and routing information attached to each hotword in the hotword list or lists referenced in the application code.

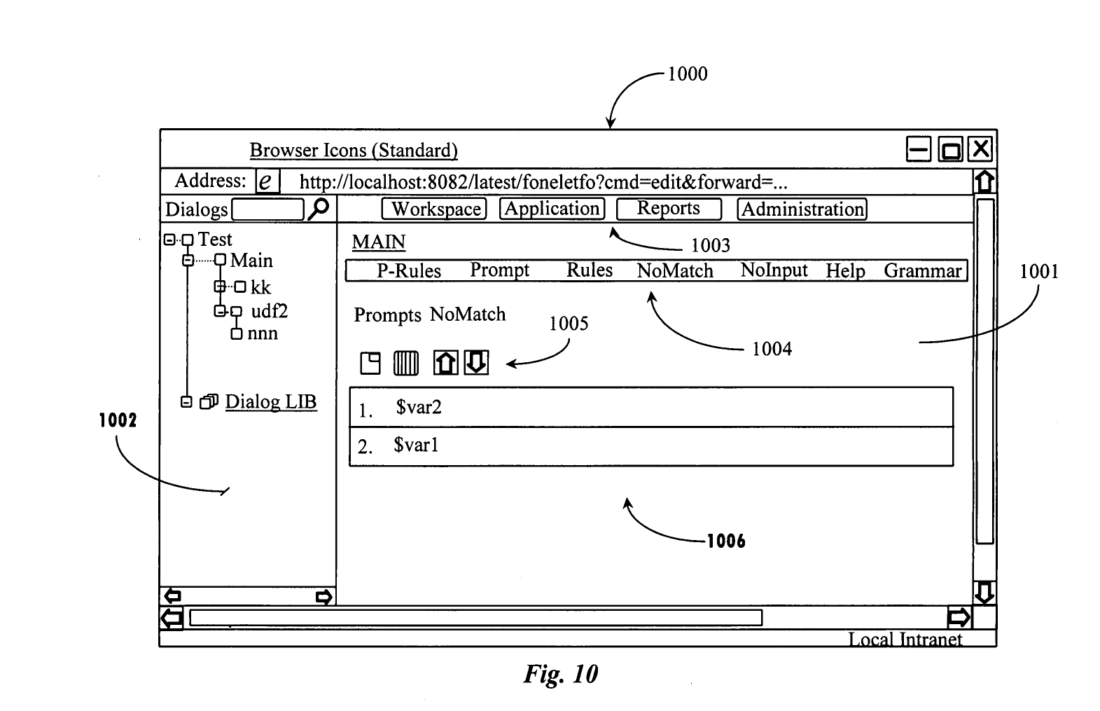

FIG. 10 represents an interactive screen 1000 of an edit-capable interface for editing or fixing error states found during validation according to an embodiment of the present invention. Screen 1000 has a navigation bar illustrated that contains all of the standard browser functional icons (so labeled). Screen 100 also has a standard address field displayed for remote users whom have navigated to the interface using browser method.

Screen 1000 has a voice dialog navigation pane 1002 provided therein, which includes a fast dialog search function for finding voice application components by name or keyword search. Pane 1002 is, in a preferred application, scrollable and has a voice application dialog tree (exemplary) including a dialog library containing all of the dialogs used by the voice applications in service or being created and tested. In this example, a root folder labeled test contains a main dialog and sub-components thereof.

Screen 1000 has a main workspace 1001 that is adapted to display components of a dialog called in navigation from a test result window similar to result screens 806 or 900 referenced in FIGS. 8B and 9 respectively. An array of options 1003 is illustrated n this example wherein the separate options workspace, application, reports, and administration are included. Workspace brings up an appropriate workspace window for editing dialog or voice application components. The exact nature and function of such a work space window will depend on which particular component is being created or corrected, in this case to satisfy an error reporting of errors found in validation.

The option application from option array 1003 is adapted to enable a user to navigate to a specific voice application from a presented list of registered applications. The option reports from option array 1003 is adapted to enable a user to view and access reports such as error reports that have been logged into the system by the VAVI. For example, a single user may be charged with validating applications and therefore may have more than one ongoing editing project created through the validation process as a result of errors found. The option administration enables an administrative view of all activity including ongoing projects being worked on and the identities of users engaged in those projects.

Workspace window 1001 supports an array of selectable options while editing. Reading from left to right, a button for listing prompt rules (P-Rules) is provided and adapted to enable a user to bring up a scrollable list of rules associated with dialog prompts used, in this case in a main voice application dialog where, previously, errors have been detected. If a user selects a next button from array 1004, labeled prompt, a list of all of the dialog prompts for the main dialog is returned and displayed.

If a user selects the next icon to the right, labeled rules, then a list of all of the existing rules associated with the main dialog is displayed in workspace window 1001. Selecting nomatch or noinput segregates the prompt list to reveal only nomatch prompts or no input prompts. There is a help icon provided for a user to obtain help with any aspect of using the interface, and a grammar button enabling a user to view all of the TTS grammar assigned to the main dialog, including any universal recognized hotwords.

Workspace 1001 has a component window 1006 provided therein and adapted to list the component type pre-selected or referenced from a validation run. In this example, window 1006 is displaying 2 variables $VAR 1 and $VAR 2 of a nomatch prompt found in a main dialog of a voice application. The reason for this particular display is that an error was found concerning one of the nomatch VARs. Revisiting FIG. 9, clicking or otherwise activating error number 1 has caused navigation to screen 1000 and display of window 1006 listing the VARs found in the nomatch prompt of the main dialog. The first error line of screen 900 identifies VAR 1 as the VAR with the problem. In one embodiment, any problem components included in a list of components may be grayed out, shaded, highlighted, or displayed using an alternate color to enable quick direction of the user to the offending component.

By selecting one of the VARs in window 1006, a user may call up a more detailed configuration/data access interface for accessing script, grammar, mapping information, description, and other particulars of the component. A user may edit and make changes to a component wherein the changes trigger a second validation run for just that component, the run transparent to the user. In an automated sequence wherein more than one error is found during a validation run, window 1006 will automatically display the next component that was found to be in error immediately after the previous component error is rectified satisfactorily.

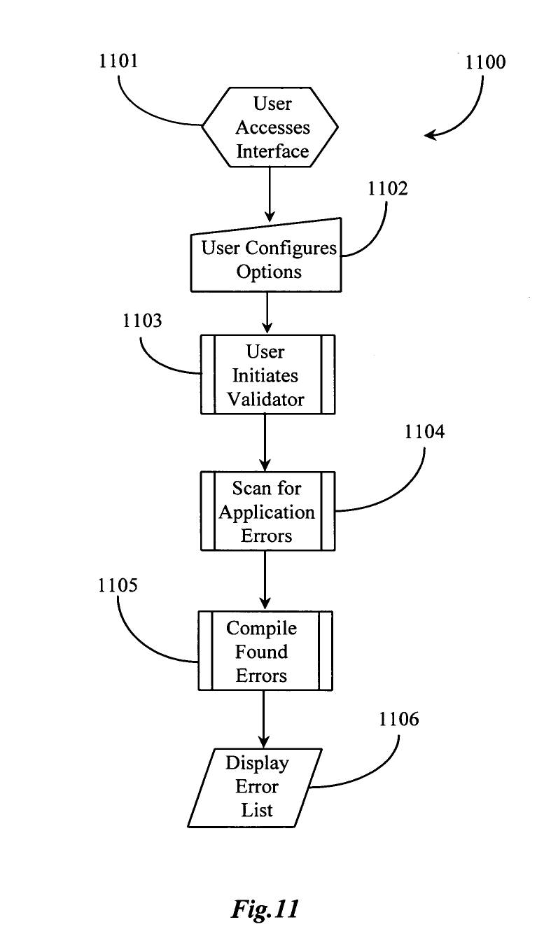

FIG. 11 is a process flow chart illustrating steps for identifying and compiling a list of voice application errors according to an embodiment of the present invention. At step 1101 a user accesses a validator interface analogous to interface 800 of FIG. 8A. At step 1102 the user selects from provided options for validating certain portions of the application. In this step a user may select all options or some of the options including selection of a single option.

At step 1103, the user initiates a validation run. At step 1104, the validator interface scans the application and application resources for errors including the existence and integrity of resources, files, mappings, data adaptor usability, and communication success between the dialog controller or processor and externally referenced data sources and files.

At step 1105, the validator interface compiles all of the errors found and noted. At step 1106, the validator interface inserts the description of each error found along with html linking or data source mapping in the form of an error list into a navigable interface or window for user review.

In one embodiment of the invention, the error list is not specifically required such as presented with reference to interface 806 of FIG. 8B or interface 900 of FIG. 9. Therefore steps 1105 and 1106 are not specifically required in order to practice the present invention. For example, the validator engine could perform error list navigation transparently from the user. In this case the user would receive an interface adapted to enable editing wherein the interface would automatically display the first error until it is rectified, followed by the next error and so on until the application has been completely validated and corrected. At this pint the application may be deployed in the field, or activated for use if already installed.

It will be apparent to one with skill in the art that the method and apparatus of the present invention may be practiced over a local area network or a wide area network without departing from the spirit and scope of the present invention. Moreover, the wide area network may be the Internet, an Intranet, or a combination of the Internet and connected sub-networks.

Validating an application or portions thereof may occur more than one time before deployment, after deployment, or in one case while an application is in service without departing from the spirit and scope of the present invention. In the case of the latter embodiment, the application validator may monitor the state of a running application and validate those portions of the application selected by a user that are not currently being accessed or used by a client. In a variation to this embodiment a voice application may be modified while in use wherein the validator interface having been configured for the portion of the application to be modified, validates and reports immediately after the modification takes place. In this way if an error is found with respect too the modification, by default the application returns to a previous state while running until the user fixes the error found with the modification.

In view of the many possible embodiments for practicing the present invention, some of which have been described, the method and apparatus of the invention should be afforded the broadest possible scope under examination. The spirit and scope of the present invention should be limited only by the following claims.

1. A software interface for validating components and resources used in one or more network-based voice applications including:
a portion for accepting user input to select component or resource types to validate;
a portion for compiling any errors or conflicts found relating to the component and resource types selected; and
a portion for displaying a list of any errors or conflicts found.

2. The software interface of claim 1 accessible from a node connected to a network local to the voice application components and resources.

3. The software interface of claim 1 accessible from a node connected to a network remote from the voice application components and resources.

4. The software interface of claim 1 wherein displayed list any errors or conflicts found is network-navigable.

5. The software interface of claim 1 integrated with an interface enabling edits and modifications.

6. The software interface of claim 1 wherein components and resources that may be validated include one or more of but are not limited to voice application variables, dialogs, dialog prompts, data adapters, scripts, external data sources, internal data sources, rules, universally recognized words, communication protocols, and thesaurus lists.

7. The software interface of claim 1 wherein validation includes one or more of validating identification of; presence of; correct application code reference to; correct internal mapping to; and correct external mapping to components and resources of type selected.

8. The software interface of claim 1 wherein the access point for operating the interface is a node on a local area network.

9. The software interface of claim 1 wherein the access point for operating the interface is a node on a wide area network.

10. The software interface of claim 5 wherein the portions for compiling and for presenting found errors or conflicts operate transparently to the operator and cause transparent navigation to each found error using the interface for editing.

11. The software interface of claim 1 wherein an error found may constitute an incorrect resource location or mapping from a dialog processor to a mapped resource or component.

12. The software interface of claim 11 wherein the incorrect location or mapping is one of a universal resource indicator or a universal resource locator.

13. The software interface of claim 6 wherein validation of rules includes validation of rule expressions.

14. A method for identifying and presenting one or more errors or conflicts related to components and resources used in one or more voice applications comprising steps of:
(a) selecting, in an interactive interface, the component and resource types of the application or applications to be considered for error identification;
(b) initiating a process for scanning the components and resources to identify and log any errors or conflicts found;
(c) scanning the identified component and resource parameters and detecting any errors or conflicts related thereto;
(d) compiling an error list of those one or more errors or conflicts logged; and
(e) displaying the list of errors and conflicts found or a certain element or elements of the list to an operator either in an edit-enabling interface or in an interface of a navigable form.

15. The method of claim 14 wherein in step (a) the interface includes a portion for excepting user input to select component or resource types to validate; a portion for compiling any errors or conflicts found relating to the component and resource types selected; and a portion for displaying a list of any errors or conflicts found.

16. The method of claim 14 wherein in step (a), the components and resources include one or more of but are not limited to voice application variables, dialogs, dialog prompts, data adapters, scripts, external data sources, internal data sources, rules, universally recognized words, communication protocols, and thesaurus lists.

17. The method of claim 14 wherein in step (a), the interface is accessible to a node connected to a network local to the voice application components and resources.

18. The method of claim 14 wherein in step (a), the interface is accessible to a node connected to a network remote from the voice application components and resources.

19. The method of claim 14 wherein in step (a), the interface is integrated with an interface enabling edits and modifications.

20. The method of claim 14 wherein in step (b), the process is initiated through the same interface of step (a).

21. The method of claim 14 wherein in steps (c) and (d) are automated and transparent to the user.

22. The method of claim 14 wherein in step (c), parameters include one or more of but are not limited to parameters about voice application variables, dialogs, dialog prompts, data adapters, scripts, external data sources, internal data sources, rules, universally recognized words, communication protocols, and thesaurus lists.

23. The method of claim 14 wherein in step (c), errors or conflicts relate to attempted validation of one or more of parameters related to identification of components or resources; presence of components or resources; correct application code reference to components or resources; correct internal mapping of components or resources; and correct external mapping of components or resources.

24. The method of claim 14 wherein in step (e), the list is presented to the edit-enabling interface as each error location is navigated to one error at a time, the navigation action transparent to the user.

25. The method of claim 14 wherein in step (e), the list is presented to the navigable interface wherein the user may physically select an item from the list causing invocation of the edit-enabling interface and navigation to the error location for editing from within the interface.
